(19) United States
(12) Patent Application Publication
(10) Pub. No.: US 2025/0379769 A1
(43) Pub. Date: Dec. 11, 2025

(54) PHASE NOISE MITIGATION

(71) Applicant: Telefonaktiebolaget LM Ericsson (publ), Stockholm (SE)

(72) Inventors: Miguel LOPEZ, Aachen (DE); Leif WILHELMSSON, Lund (SE); Dennis SUNDMAN, Sollentuna (SE); Mehrnaz AFSHANG, Fremont, CA (US)

(21) Appl. No.: 19/127,905

(22) PCT Filed: Nov. 8, 2023
(86) PCT No.: PCT/EP2023/081206

§ 371 Date: May 7, 2025

Related U.S. Application Data
(60) Provisional application No. 63/424,038, filed on Nov. 9, 2022.

(51) Int. Cl. H04L 25/03; H04L 5/00; H04L 27/26

(52) U.S. Cl. CPC H04L 25/03821; H04L 5/0007; H04L 5/0048; H04L 27/2602; H04L 27/2666

(57) ABSTRACT

A method, network node and wireless device (WD) for phase noise mitigation are disclosed. According to one aspect, a method in a network node includes receiving an orthogonal frequency division multiplex (OFDM) signal provided over a radio frequency (RF) channel that includes at least one guard band, the OFDM signal including at least one pilot signal. The method also includes mitigating phase noise based at least in part on the at least one pilot signal and further based on observations of signal content of the at least one guard band.

### FIELD

The present disclosure relates to wireless communications, and in particular, to phase noise mitigation.

### INTRODUCTION

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

In addition to these standards, the Institute of Electrical and Electronic Engineers (IEEE) has developed and continues to develop standards for other types of wireless communication networks, including Wireless Local Area Networks (WLANs), including Wireless Fidelity (Wi-Fi) networks. WLANS include wireless communication between access points (APs) and WDs.

The IEEE 802.11 has recently created an Ultra High Reliability (UHR) study group whose objective is to develop a Project Authorization Request (PAR) and a Criteria for Standards Development (CSD) for a new 802.11 MAC/PHY amendment. One of the proposals being considered is to standardize multi-link operation (MLO) with one of the links operating at a carrier frequency between 45 GHz and 71 GHz. Even though IEEE 802.11 has standardized a mm Wave PHY (IEEE 802.11ad/ay), there has been consideration of defining a new PHY for mm Wave by upconverting and upclocking the 802.11ac or the 802.11ax PHY. For example, by upclocking 8× the 802.11ac PHY, a subcarrier spacing of 2.5 MHz is obtained, and the sub-7 GHz channels of bandwidths 20/40/80/160 MHz become 160/320/640/1280 MHz wide. The rationale is that operation in mm Wave offers many advantages, including lower latency, huge capacity increase and increased peak throughput. This PHY design based on upclocking/upconversion allows the re-use of baseband algorithms and reduces development time. Compared to the IEEE 802.11ad/ay standards, the combination of MLO and the new PHY design may bring the device complexity to levels that are realistic for high-end Wi-Fi devices.

It is well known that phase noise is a challenge for orthogonal frequency division multiplexing (OFDM) systems operating in mm Wave. Phase noise is generally due to imperfections in the oscillators and may appear at both the transmitter and the receiver. The phase noise power typically increases by 6 dB for every doubling of the carrier frequency. The presence of phase noise may cause inter-carrier interference (ICI), which destroys the frequency domain orthogonality of OFDM signals. In general, a large subcarrier spacing tends to reduce the ICI. ICI may be very harmful because it may limit the maximum attainable signal to interference plus noise ratio (SINR) at the receiver, and hence limits the peak rates. For this reason, ICI mitigation has been the subject of numerous investigations, and the 3GPP introduced a phase tracking reference signal (PTRS) in the NR air interface. These reference symbols may be used for ICI suppression and carrier frequency offset compensation. For example, the PTRS may be used to design de-ICI filters that are very effective in suppressing ICI, have low computational complexity and lead to increased throughput in NR systems.

### Phase Noise Compensation

Let the transmitted symbol and the channel response for sub-carrier k be Sₖ and Hₖ, respectively. The time-varying phase noise induces inter-carrier-interference (ICI) in the frequency domain received signal Rₖ:

$${R}_{k} = {\sum }_{i} {J}_{i} {H}_{k - i} {S}_{k - i} + {W}_{k} .$$

where, Jᵢ are the DFT coefficients of the PN and Wₖ is white Gaussian noise. The following two compensation approaches are presented. In the first, a filter on the received signal Rₖ is estimated directly such that the filtered received signal becomes approximately free of ICI. In the second, the ICI filter {Jᵢ} induced by the phase noise is estimated first. In this approach, the received signal is then filtered by the conjugate reverse of the estimated ICI filter.

### Direct De-ICI Filtering Approach

PTRS are transmitted on sub-carriers k₀, k₁, . . . , k_{N-1}. The values of Xₖ at these sub-carriers are hence known and may be used to estimate a de-ICI filter of 2u+1 taps:

$${\sum }_{m = - u}^{u} {a}_{m} {R}_{k - m} \approx {H}_{k} {X}_{k} for k ∈ \{ {k}_{0} , {k}_{1} , … , {k}_{N - 1} \} .$$

For u=0, the de-ICI filter reduces to single-tap common phase error (CPE) compensation:

$${\hat{a}}_{0} = {argmin}_{{a}_{0}} {‖ [ \begin{matrix}{R}_{{k}_{0}} \\ ⋮ \\ {R}_{{k}_{N - 1}}\end{matrix} ] {a}_{0} - [ \begin{matrix}{H}_{{k}_{0}} {X}_{{k}_{0}} \\ ⋮ \\ {H}_{{k}_{N - 1}} {X}_{{k}_{N - 1}}\end{matrix} ] ‖}^{2} {=}^{Δ} {argmin}_{{a}_{0}} {‖ {R}_{0} {a}_{0} - x ‖}^{2} = {( {R}_{0}^{H} {R}_{0} )}^{- 1} {R}_{0}^{H} x .$$

For ICI compensation, the (2u+1)-tap de-ICI filter may be obtained from minimizing the residue sum of squares:

$${‖ [ \begin{matrix}{R}_{{k}_{0} + u} & {R}_{{k}_{0} + u - 1} & ⋯ & {R}_{{k}_{0} - u} \\ {R}_{{k}_{1} + u} & {R}_{{k}_{1} + u - 1} & ⋯ & {R}_{{k}_{1} - u} \\ ⋮ & ⋮ & ⋱ & ⋮ \\ {R}_{{k}_{N - 1} + u} & {R}_{{k}_{N - 1} + u - 1} & ⋯ & {R}_{{k}_{N - 1} - u}\end{matrix} ] [ \begin{matrix}{a}_{- u} \\ {a}_{- u + 1} \\ ⋮ \\ {a}_{u}\end{matrix} ] - x ‖}^{2} {=}^{Δ} {‖ {R}_{u} {a}_{u} - x ‖}^{2} .$$

This is a least square problem with solution given by

$${\hat{a}}_{u} = {( {R}_{u}^{H} {R}_{u} )}^{- 1} {R}_{u}^{H} x .$$

Note that

$${R}_{u}^{H} {R}_{u}$$

is a (2u+1)×(2u+1) matrix. The performance differences between u=1 and u=2 have been investigated. For u=1 and u=2,

$${R}_{u}^{H} {R}_{u}$$

are hence small 3×3 and 5×5 matrices, respectively. To compensate the ICI, the received signal {Rₖ} is filter by {â₋ᵤ, â₋ᵤ₊₁, . . . , âᵤ} and then fed to the OFDM demodulator.

Phase noise is a concern when upconverting a sub-7 GHz PHY to mm Wave, as it may limit the peak rates that may be achieved in practice.

The 802.11ac/ax PHYs include so-called pilots, which are meant for phase tracking and may also be used in the estimation of ICI and the design of ICI mitigation algorithms. However, the number of pilots is very limited. For example, the 802.11ac PHY specifies 4 pilots when the channel bandwidth is 20 MHz and 6 pilots for 40 MHz channels. It is challenging to obtain good performance with ICI suppression algorithms when having so few pilots. A straightforward solution is to add more pilots. However, this would require re-designing the PHY, and the 802.11ac/ax TX/RX algorithms would require updates. This would be a major task, as it would require the re-definition of channel coding and modulation. This this solication is undesirable.

### SUMMARY

Some embodiments advantageously provide methods, systems, and apparatuses for phase noise mitigation.

OFDM signals do not occupy the entire RF channel but have unused portions called guard bands. The guard bands are located at the band edges, and in the case of OFDMA transmissions, may also be located at arbitrary places within the channel, as illustrated in the example diagram of FIG. 1, which illustrates guard bands. FIG. 2 is a diagram showing spectrum leakage due to phase noise.

Some embodiments include collecting frequency domain samples corresponding to the guard bands, and using them together with a-priori knowledge that no information is transmitted in the guard bands. Thus, the information about the phase noise provided by the pilots may be enhanced with information provided by the guard band to improve the performance of the phase noise mitigation algorithms.

Some embodiments mitigate phase noise without increasing the overhead, i.e., no new reference symbols are added or if new reference symbols are added, this is done in a way that does not reduce the maximum achievable data rate.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram illustrating guard bands;

FIG. 2 illustrates an example of spectrum leakage due to phase noise;

FIG. 3 is a schematic diagram of an example network architecture illustrating a communication system according to principles disclosed herein;

FIG. 4 is a block diagram of a network node in communication with a wireless device over a wireless connection according to some embodiments of the present disclosure;

FIG. 5 is a flowchart of an example process in a network node for phase noise mitigation;

FIG. 6 is a flowchart of an example process in a wireless device for phase noise mitigation;

FIG. 7 is first example of a noise-impaired received signal;

FIG. 8 is a first example of a noise-impaired received signal with de-ICI applied; and

FIG. 9 is a second example of a noise-impaired received signal with de-ICI applied.

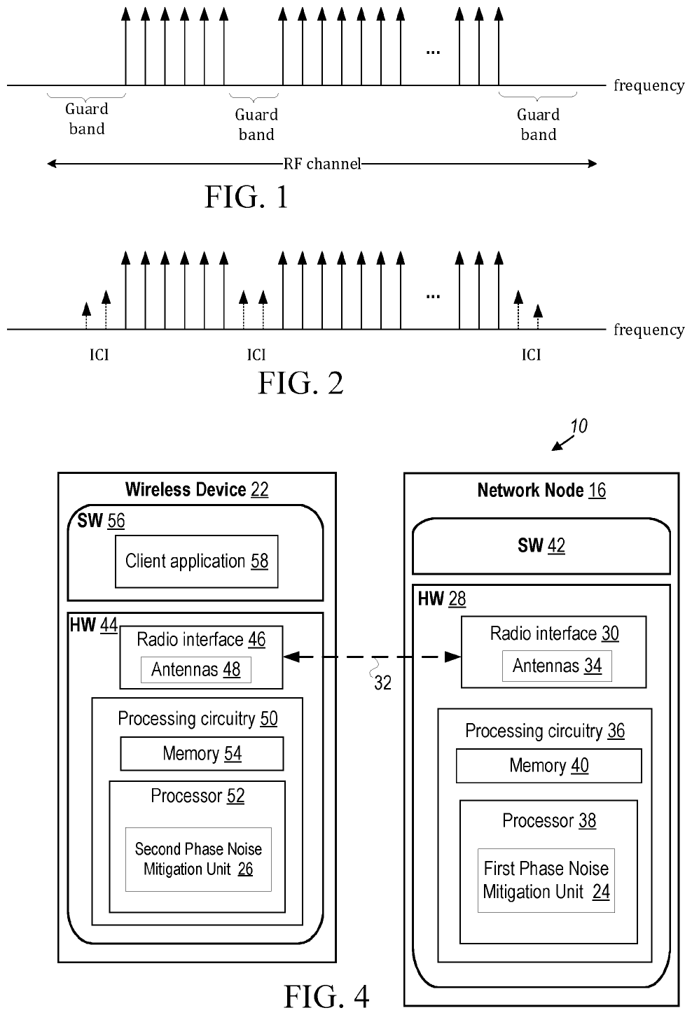

### DETAILED DESCRIPTION

Before describing in detail example embodiments, it is noted that the embodiments reside primarily in combinations of apparatus components and processing steps related to phase noise mitigation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node included in a radio network which may further include any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also include test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals. The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device etc.

Also, in some embodiments the generic term “radio network node” is used. It may be any kind of a radio network node which may include any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, IEEE 802.11, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to phase noise mitigation for wireless communications.

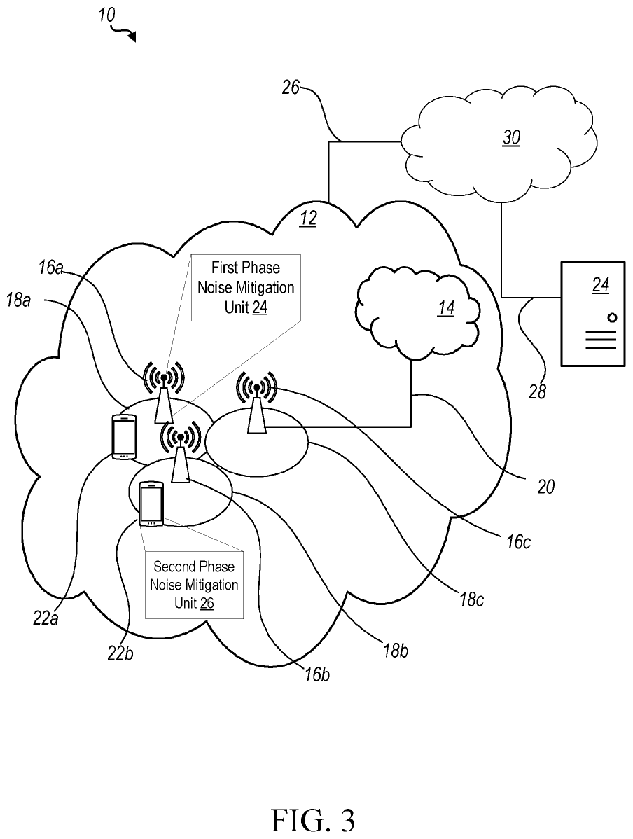

Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which includes an access network 12, such as a radio access network, and a core network 14. The access network 12 includes a plurality of network nodes 16a, 16b, 16c (referred to collectively as network nodes 16), such as APs, NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an AP for WLAN, an eNB for LTE/E-UTRAN and a gNB for NR/NG-RAN.

A network node 16 (AP, eNB or gNB) is configured to include a first phase noise mitigation unit 24 which is configured to mitigate phase noise based at least in part on the at least one pilot signal and further based on observations of signal content of the at least one guard band. A wireless device 22 may also be configured to include a second phase noise mitigation unit 26 which is also configured to mitigate phase noise based at least in part on the at least one pilot signal and further based on observations of signal content of the at least one guard band. Note that phase noise mitigation units 24 and 26 may be employed in radio units of network devices other than network nodes and WDs. As such, the explanation of phase noise mitigation within the context of network nodes 16 and wireless devices 22 is purely for ease of understanding and explanation.

Example implementations, in accordance with an embodiment, of the WD 22 and network node 16 discussed in the preceding paragraphs will now be described with reference to FIG. 4.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a first phase noise mitigation unit 24 which is configured to mitigate phase noise based at least in part on the at least one pilot signal and further based on observations of signal content of the at least one guard band.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory)

Thus, the WD 22 may further include software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a second phase noise mitigation unit 26 which is also configured to mitigate phase noise based at least in part on the at least one pilot signal and further based on observations of signal content of the at least one guard band.

In some embodiments, the inner workings of the network node 16 and WD 22 may be as shown in FIG. 4 and independently, the surrounding network topology may be that of FIG. 3.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 3 and 4 show various “units” such as first phase noise mitigation unit 24 and second phase noise mitigation unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

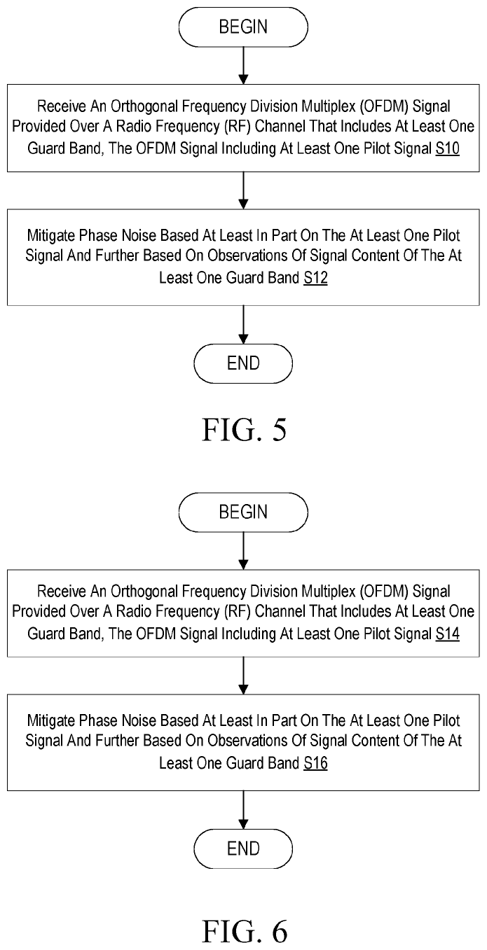

FIG. 5 is a flowchart of an example process in a network node 16 for phase noise mitigation. One or more blocks described herein may be performed by one or more elements of network node 16 such as by one or more of processing circuitry 36 (including the first phase noise mitigation unit 24), processor 38, and/or radio interface 30. Network node 16 such as via processing circuitry 36 and/or processor 38 and/or radio interface 30 is configured to receive an orthogonal frequency division multiplex (OFDM) signal provided over a radio frequency (RF) channel that includes at least one guard band, the OFDM signal including at least one pilot signal (Block S10). The process also includes mitigating phase noise based at least in part on the at least one pilot signal and further based on observations of signal content of the at least one guard band (Block S12).

In some embodiments, mitigating the phase noise includes determining a deviation of the signal content of the at least one guard band from an expected signal content and mitigating the phase noise based on the deviation. In some embodiments, the OFDM signal has subcarriers indexed from −N_{SR} to N_{SR}, and receiving the OFDM signal includes determining an N-point discrete Fourier transform (DFT), where N>2×N_{SR}+1 such that N−2×N_{SR}−1 subcarriers are outside the OFDM signal but within the N-point DFT. In some embodiments, mitigating the phase noise includes determining a filter and applying the filter to the OFDM signal. In some embodiments, the method further includes selecting the at least one guard band to observe signal content based at least in part on a presence of signals adjacent to a guard band of the at least one guard band and a presence of interference in a guard band of the at least one guard band. In some embodiments, a number of guard bands for observation of signal content is based on a bandwidth of the OFDM signal. In some embodiments, the larger the bandwidth of the OFDM signal, the fewer the guard bands for observation of signal content.

FIG. 6 is a flowchart of an example process in a wireless device 22 according to some embodiments of the present disclosure. One or more blocks described herein may be performed by one or more elements of wireless device 22 such as by one or more of processing circuitry 50 (including the second phase noise mitigation unit 26), processor 52, and/or radio interface 46. Wireless device 22 such as via processing circuitry 50 and/or processor 52 and/or radio interface 46 is configured to receive an orthogonal frequency division multiplex (OFDM) signal provided over a radio frequency (RF) channel that includes at least one guard band, the OFDM signal including at least one pilot signal (Block S14). The process also includes mitigating phase noise based at least in part on the at least one pilot signal and further based on observations of signal content of the at least one guard band (Block S16).

In some embodiments, mitigating the phase noise includes determining a deviation of the signal content of the at least one guard band from an expected signal content and mitigating the phase noise based on the deviation. In some embodiments, the OFDM signal has subcarriers indexed from −N_{SR} to N_{SR}, and receiving the OFDM signal includes determining an N-point discrete Fourier transform (DFT), where N>2×N_{SR}+1 such that N−2×N_{SR}−1 subcarriers are outside the OFDM signal but within the N-point DFT. In some embodiments, mitigating the phase noise includes determining a filter and applying the filter to the OFDM signal. In some embodiments, the method also includes selecting the at least one guard band to observe signal content based at least in part on a presence of signals adjacent to a guard band of the at least one guard band and a presence of interference in a guard band of the at least one guard band. In some embodiments, a number of guard bands for observation of signal content is based on a bandwidth of the OFDM signal. In some embodiments, the larger the bandwidth of the OFDM signal, the fewer the guard bands for observation of signal content.

Having described the general process flow of arrangements of the disclosure and having provided examples of hardware and software arrangements for implementing the processes and functions of the disclosure, the sections below provide details and examples of arrangements for phase noise mitigation.

As an example, ICI suppression has been the subject of extensive research. For example, a low complexity algorithm has proven to be very effective. This algorithm may be enhanced and applied to an up-clocked version of 802.11ac in the 60 GHz band.

With some slight adjustments which are not relevant to the current explanation, 802.11ac/ax specify the baseband transmitted signal as an inverse discrete Fourier transform (IDFT) of the following form.

$$x ( t ) = {\sum }_{k = - {N}_{SR}}^{{N}_{SR}} {X}_{k} exp ( j 2 π k Δ ft ) . \qquad Equation 1$$

Here N_{SR} is the index of the highest used subcarrier, Δf is the subcarrier spacing and Xₖ are the frequency domain symbols that include data and pilots. For example, when the channel bandwidth is 20 MHz, 802.11ac specifies a value of N_{SR}=28. Thus, the transmitted signal includes 57=2N_{SR}+1 subcarriers: 52 carry data, 4 pilots and one DC subcarrier that is muted (X₀=0). In the absence of phase noise and non-linear impairments, the received signal may be written in the form r(t)=h*x(t)+w(t) where h denotes the channel and w is an additive noise term. The frequency domain received signal may be expressed in the form Rₖ=HₖXₖ+Wₖ, −N_{SR}≤k≤N_{SR}, where Hₖ is the frequency domain channel coefficient and Wₖ is an additive noise term. In the presence of phase noise, a frequency domain received sample Rₖ also includes contributions from nearby modulation symbols . . . , Xₖ₋₂, Xₖ₋₁, Xₖ, Xₖ₊₁, . . . (hence the name ICI). For example, the ICI algorithms described herein may be implemented by the processing circuitries 36 and 50 including the first and second phase noise mitigation units 24 and 26, respectively.

In some embodiments, the algorithm takes as input the frequency domain samples and the pilot symbols and computes an L-tap filter. This filter is applied to the frequency domain received samples by the processing circuitry 36, 50. Simulations show that as little as L=3 filter taps yield very good performance. To derive the filter, an over-determined system of equations is set up. Each pilot gives rise to one equation. The filter coefficients are found by computing an approximate solution to the system of equations. Increasing the number of pilots leads to reduced variance of the estimated filter coefficients.

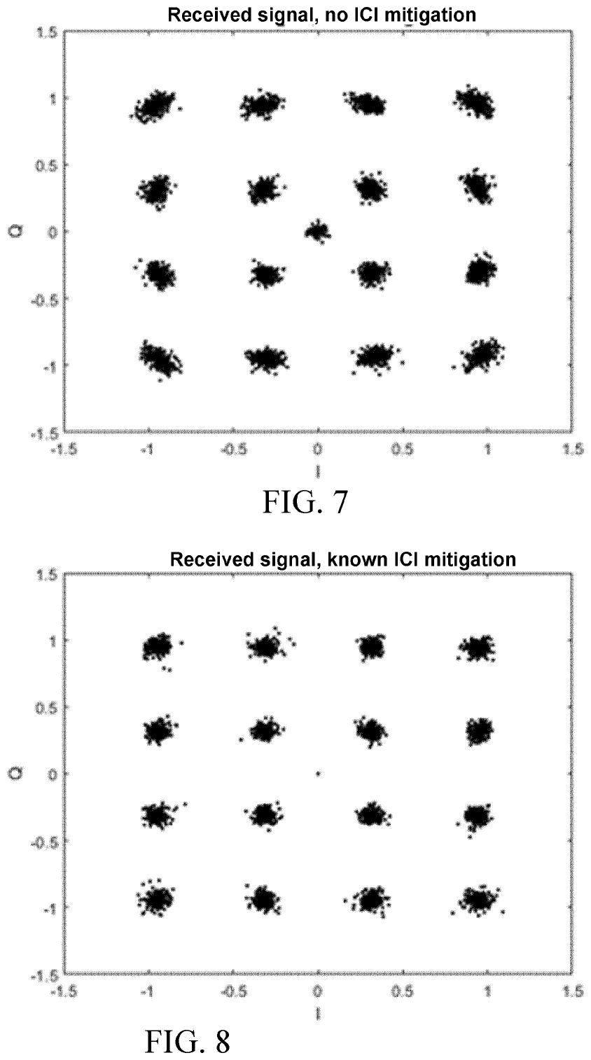

FIG. 7 illustrates the received signal in the frequency domain when using an 8X upclocked version of the 802.11ac PHY (160 MHz channel bandwidth, 2.5 MHz subcarrier spacing) at a center frequency of 60 GHz. The signal has been impaired by phase noise with PSD:

$$PSD ( f ) = - 90 + 10 log 10 ( 1 + {( \frac{f}{100 E 6} )}^{2} ) - 10 log 10 ( 1 + {( \frac{f}{1 E 6} )}^{2} ) \frac{dBc}{Hz} .$$

In this example, the signal is impaired by the phase noise once (for example at the TX side), but in practice, the signal is impaired by phase noise in both the TX and RX. The SINR=26.8 dB has been estimated from the received samples.

Next, the disclosed de-ICI algorithm is applied via the processing circuitry 36, 50. In this example the 802.11ac PHY includes 4 pilots in each OFDM symbol. The pilot indices are {−21,−7,7,21}. The inputs to the algorithm are the received frequency domain samples {Rₖ:−28≤k≤28}, the pilot indices {−21,−7,7,21} and the pilots {X₋₂₁, X₋₇, X₇, X₂₁}. The algorithm sets up a system of 4 equations and L=3 unknowns, as explained in the introduction. Despite the small number of equations, the de-ICI filter is effective, increasing the SINR by 2.6 dB, as illustrated in FIG. 8.

The de-ICI algorithm is enhanced as follows. Note first that the receiver of the radio interface 30, 36 may perform a discrete Fourier transform (DFT), and that in practice the supported DFT sizes are chosen to enable efficient computation of the Fourier transform. For example, the 802.11ac 20 MHz waveform is defined using a 57-point IDFT (equation 1), but at the receiver side the time domain received signal may be analyzed applying a 64-point DFT. Moreover, notice that one may express the transmitted signal given in equation 1 in the form:

$$x ( t ) = {\sum }_{k = - 32}^{31} {X}_{k} exp ( j π k Δ ft ) ,$$

$$where$$

$${X}_{- 32} = {X}_{- 31} = {X}_{- 30} = {X}_{- 29} = {X}_{29} = {X}_{30} = {X}_{31} = 0 .$$

When a 64-point DFT is applied to the received signal, the frequency domain received samples {Rₖ:−32≤k≤31} are obtained. In the absence of thermal noise and non-linearities/phase noise, the following must be true.

$${R}_{- 32} = {R}_{- 31} = {R}_{- 30} = {R}_{- 29} = {R}_{29} = {R}_{30} = {R}_{31} = 0 .$$

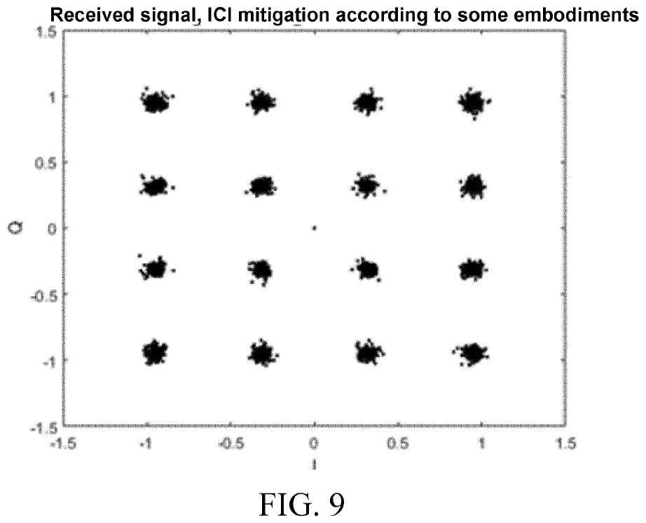

However, in the presence of non-linearities/phase noise, and even if the SNR is so high that the thermal noise may be neglected, these frequency domain samples will not be zero, as illustrated in FIG. 9. In fact, these samples contain valuable information regarding the non-linear impairments, and this information may be advantageously used to improve any ICI mitigation algorithm. In addition, one may consider the frequency domain symbols X₋₃₂, . . . , X₋₂₉, X₂₉, . . . . X₃₁ as virtual pilots.

The reason to call them virtual is that these modulation symbols correspond to subcarriers in the guard band and were not transmitted. However, knowing that they may be included in the signal model, and knowing that their value is a-priori zero is helpful when designing de-ICI algorithms, as will be illustrated below.

To enhance the de-ICI algorithm proceed as follows. Synthesize virtual pilots at subcarrier indices {−29,29} which correspond to parts of the guard band. These are given the values X₋₂₉=X₂₉=0 since it is known a-priori that no modulation symbols were transmitted in the frequencies corresponding to the guard band. In this way the subcarrier indices may be enlarged to {−29,−21,−7,7,21,29} and the set of pilots to {0,X₋₂₁,X₋₇,X₇,X₂₁,0}. The next step is to feed the subcarrier indices {−29,−21,−7,7,21,29}, the set of pilots {0,X₋₂₁,X₋₇,X₇,X₂₁,0} and the enlarged set of frequency domain received samples {Rₖ:−32≤k≤31} to de-ICI algorithm. The algorithm sets up a system of 6 equations with 3 unknowns, from which the de-ICI filter coefficients are estimated. Note that even though only 2 virtual pilots have been added, the number of equations has been increased by 50% with respect to prior art. The result is less noisy estimates of the filter coefficients. The de-ICI filter thus obtained is effective, resulting in a 4 dB increase of the SINR, as illustrated in FIG. 9

In summary, the simulations show that applying a low-complexity 3-tap de-ICI filter to an 8× upclocked 802.11 PHY increases the SINR by 2.6 dB and that enhancing the computation of the 3-tap de-ICI filter according to methods disclosed herein gives an additional 1.4 dB gain (for a total of 2.6+1.4=4 dB SINR increase). In practice, a 4 dB increase in SINR means that a higher data rate may be used.

More generally, some embodiments use the enlarged sets of received samples and pilots to better estimate the ICI and design better ICI mitigation algorithms. Enlarging the set of received samples consists of including frequency domain samples corresponding to subcarriers in the guard bands. Enlarging the set of pilots means adding virtual pilots whose value is known to be zero a-priori and which have subcarrier indices corresponding to the guard band.

In typical UHR deployments in mm Wave it is expected that, at least initially, only single user mode of operation is supported, and that due to the spectrum availability and path loss the operation of other stations in adjacent channels may be neglected. However, if OFDMA is enabled, or if uncoordinated neighboring access points (APs) operate in adjacent mm Wave channels, it may happen that the received signal includes unwanted emissions from other users. In this case, the amount of interference in the guard band may not be negligible and it might be advantageous to not use the portion of the guard band affected by the interference when performing ICI mitigation.

For example, in 802.11ax, the smallest bandwidth allocations for OFDMA include only a couple of pilots, but there are guard bands separating the allocations of different users. Also, stations (STAs) often have worse transmitter/receiver accuracy than APs, so that the phase noise is often dominated by the imperfections in the transceiver in the STA. Thus, for UL OFDMA transmissions it might be best to avoid using the guard band separating two adjacent users, while in the DL the STAs may advantageously use the said guard band to perform ICI estimation. Note that for DL OFDMA, the STA may use pilots in the Data part for other STAs to mitigate ICI. Furthermore in DL OFDMA, a STA1 may also use the guard band between STA2 and STA3 to perform ICI estimation.

Some embodiments may include one or more of the following:
1. A phase noise mitigation method for an OFDM signal provided over an RF channel, which RF channel includes one or more guard bands in which no or only predefined signals are transmitted, and the OFDM signal comprises one or more pilot signals, the method comprising
receiving the OFDM signal and the one or more guard bands; and
mitigating phase noise based on the one or more pilot signals,
the method being characterized by:
observing signal content present in the one or more guard bands;
determining deviation from the lack of signal or predefined signal of the signal content; and
further mitigating the phase noise based on the determined deviation.
2. The method of Embodiment 1, wherein the OFDM signal has subcarriers indexed from −N_{SR} to N_{SR}, and receiving the OFDM signal and one or more guard bands involves an N-point DFT, where N>2×N_{SR}+1 such that the N−2×N_{SR}−1 subcarriers outside the OFDM signal but within the N-point DFT provide the signal content.
3. The method of Embodiments 1 or 2, comprising
based on the determined deviation, providing a filter for mitigating the phase noise; and
applying the filter in frequency domain to the received signal.
4. The method of any one of Embodiments 1 to 3, comprising
selecting the one or more guard bands to observe signal content from, wherein the selecting is based on any one or more of:
determine presence of adjacent signals to the one or more guard bands;
acquired information about the one or more guard bands; and
determined presence of other interference in the one or more guard bands.
5. The method of any one of Embodiments 1 to 4, wherein the amount of guard bands to observe is based on bandwidth of the OFDM signal.
6. The method of Embodiment 5, wherein the larger the bandwidth, the less amount of guard bands to observe is used.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| ACK | Acknowledgment |
| AP | Access Point |
| CSD | Criteria for Standard Development |
| CRC | Cyclic Redundancy Check |
| CTS | Clear To Send |
| CW | Codeword |
| ICI | Inter-carrier interference |
| MLO | Multi Link Operation |
| NACK | Negative ACK |
| OFDMA | Orthogonal Frequency Division Multiple Access |
| PAR | Project Authorization Request |
| PPDU | Physical Protocol Data Unit |
| PN | Phase noise |
| PTRS | Phase Tracking Reference Signal |
| RU | Resource Unit |
| SIFS | Short Inter-Frame Space |
| STA | Station |
| TXOP | Transmit Opportunity |
| UHR | Ultra High Reliability |
| XR | Extended Reality |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### EXAMPLE EMBODIMENTS

Embodiment A1. A network node configured to communicate with a wireless device (WD), the network node configured to, and/or comprising a radio interface and/or comprising processing circuitry configured to:
receive an orthogonal frequency division multiplex (OFDM) signal provided over a radio frequency (RF) channel that includes at least one guard band, the OFDM signal including at least one pilot signal; and
mitigate phase noise based at least in part on the at least one pilot signal and further based on observations of signal content of the at least one guard band.
Embodiment A2. The network node of Embodiment A2, wherein mitigating the phase noise includes determining a deviation of the signal content of the at least one guard band from an expected signal content and mitigating the phase noise based on the deviation.
Embodiment A3. The network node of any of Embodiments A1 and A2, wherein the OFDM signal has subcarriers indexed from −N_{SR} to N_{SR}, and receiving the OFDM signal includes determining an N-point discrete Fourier transform (DFT), where N>2×N_{SR}+1 such that N−2×N_{SR}−1 subcarriers are outside the OFDM signal but within the N-point DFT.
Embodiment A4. The network node of any of Embodiments A2 and A3, wherein mitigating the phase noise includes determining a filter and applying the filter to the OFDM signal.
Embodiment A5. The network node of any of Embodiments A1-A4, wherein the network node, radio interface and/or processing circuitry are configured to select the at least one guard band to observe signal content based at least in part on a presence of signals adjacent to a guard band of the at least one guard band and a presence of interference in a guard band of the at least one guard band.
Embodiment A6. The network node of any of Embodiments A1-A5, wherein a number of guard bands for observation of signal content is based at least in part on a bandwidth of the OFDM signal.
Embodiment A7. The network node of Embodiment A6, wherein, the larger the bandwidth of the OFDM signal, the fewer the guard bands for observation of signal content.
Embodiment B1. A method implemented in a network node that is configured to communicate with a wireless device, the method comprising:
receiving an orthogonal frequency division multiplex (OFDM) signal provided over a radio frequency (RF) channel that includes at least one guard band, the OFDM signal including at least one pilot signal; and
mitigating phase noise based at least in part on the at least one pilot signal and further based on observations of signal content of the at least one guard band.
Embodiment B2. The method of Embodiment B2, wherein mitigating the phase noise includes determining a deviation of the signal content of the at least one guard band from an expected signal content and mitigating the phase noise based at least in part on the deviation.
Embodiment B3. The method of any of Embodiments B1 and B2, wherein the OFDM signal has subcarriers indexed from −N_{SR} to N_{SR}, and receiving the OFDM signal includes determining an N-point discrete Fourier transform (DFT), where N>2×N_{SR}+1 such that N−2×N_{SR}−1 subcarriers are outside the OFDM signal but within the N-point DFT.
Embodiment B4. The method of any of Embodiments B2 and B3, wherein mitigating the phase noise includes determining a filter and applying the filter to the OFDM signal.
Embodiment B5. The method of any of Embodiments B1-B4, further comprising selecting the at least one guard band to observe signal content based at least in part on a presence of signals adjacent to a guard band of the at least one guard band and a presence of interference in a guard band of the at least one guard band.
Embodiment B6. The method of any of Embodiments B1-B5, wherein a number of guard bands for observation of signal content is based at least in part on a bandwidth of the OFDM signal.
Embodiment B7. The method of Embodiment B6, wherein, the larger the bandwidth of the OFDM signal, the fewer the guard bands for observation of signal content.
Embodiment C1. A wireless device (WD) configured to communicate with a network node, the WD configured to, and/or comprising a radio interface and/or processing circuitry configured to:
receive an orthogonal frequency division multiplex (OFDM) signal provided over a radio frequency (RF) channel that includes at least one guard band, the OFDM signal including at least one pilot signal; and
mitigate phase noise based at least in part on the at least one pilot signal and further based on observations of signal content of the at least one guard band.
Embodiment C2. The WD of Embodiment C2, wherein mitigating the phase noise includes determining a deviation of the signal content of the at least one guard band from an expected signal content and mitigating the phase noise based at least in part on the deviation.
Embodiment C3. The WD of any of Embodiments C1 and C2, wherein the OFDM signal has subcarriers indexed from −N_{SR} to N_{SR}, and receiving the OFDM signal includes determining an N-point discrete Fourier transform (DFT), where N>2×N_{SR}+1 such that N−2×N_{SR}−1 subcarriers are outside the OFDM signal but within the N-point DFT.
Embodiment C4. The WD of any of Embodiments C2 and C3, wherein mitigating the phase noise includes determining a filter and applying the filter to the OFDM signal.
Embodiment C5. The WD of any of Embodiments C1-C4, wherein the network node, radio interface and/or processing circuitry are configured to select the at least one guard band to observe signal content based at least in part on a presence of signals adjacent to a guard band of the at least one guard band and a presence of interference in a guard band of the at least one guard band.
Embodiment C6. The WD of any of Embodiments C1-C5, wherein a number of guard bands for observation of signal content is based at least in part on a bandwidth of the OFDM signal.
Embodiment C7. The WD of Embodiment C6, wherein, the larger the bandwidth of the OFDM signal, the fewer the guard bands for observation of signal content.
Embodiment D1. A method implemented in a wireless device (WD) that is configured to communicate with a network node, the method comprising:
receiving an orthogonal frequency division multiplex (OFDM) signal provided over a radio frequency (RF) channel that includes at least one guard band, the OFDM signal including at least one pilot signal; and
mitigating phase noise based at least in part on the at least one pilot signal and further based on observations of signal content of the at least one guard band.
Embodiment D2. The method of Embodiment D2, wherein mitigating the phase noise includes determining a deviation of the signal content of the at least one guard band from an expected signal content and mitigating the phase noise based at least in part on the deviation.
Embodiment D3. The method of any of Embodiments D1 and D2, wherein the OFDM signal has subcarriers indexed from −N_{SR} to N_{SR}, and receiving the OFDM signal includes determining an N-point discrete Fourier transform (DFT), where N>2×N_{SR}+1 such that N−2×N_{SR}−1 subcarriers are outside the OFDM signal but within the N-point DFT.
Embodiment D4. The method of any of Embodiments D2 and D3, wherein mitigating the phase noise includes determining a filter and applying the filter to the OFDM signal.
Embodiment D5. The method of any of Embodiments D1-D4, further comprising selecting the at least one guard band to observe signal content based at least in part on a presence of signals adjacent to a guard band of the at least one guard band and a presence of interference in a guard band of the at least one guard band.
Embodiment D6. The method of any of Embodiments D1-D5, wherein a number of guard bands for observation of signal content is based at least in part on a bandwidth of the OFDM signal.
Embodiment D7. The method of Embodiment D6, wherein, the larger the bandwidth of the OFDM signal, the fewer the guard bands for observation of signal content.

1. A network node configured to communicate with a wireless device, WD, the network node comprising one or both of a radio interface and processing circuitry configured to:
receive an orthogonal frequency division multiplex, OFDM, signal provided over a radio frequency, RF, channel that includes at least one guard band, the OFDM signal including at least one pilot signal; and
mitigate phase noise based at least in part on the at least one pilot signal and further based on observations of signal content of the at least one guard band.

2. The network node of claim 1, wherein mitigating the phase noise includes determining a deviation of the signal content of the at least one guard band from an expected signal content and mitigating the phase noise based on the deviation.

3. The network node of claim 1, wherein the OFDM signal has subcarriers indexed from −N_{SR} to N_{SR}, and receiving the OFDM signal includes determining an N-point discrete Fourier transform, where N>2×N_{SR}+1 such that N−2×N_{SR}−1 subcarriers are outside the OFDM signal but within the N-point DFT.

4. (canceled)

5. The network node of claim 1, wherein the one or both of the radio interface and processing circuitry are configured to select the at least one guard band to observe signal content based at least in part on a presence of signals adjacent to a guard band of the at least one guard band and a presence of interference in a guard band of the at least one guard band.

6. The network node of claim 1, wherein a number of guard bands for observation of signal content is based at least in part on a bandwidth of the OFDM signal, wherein the larger the bandwidth of the OFDM signal, the fewer the guard bands for observation of signal content.

7. (canceled)

8. A method implemented in a network node that is configured to communicate with a wireless device, the method comprising:
receiving an orthogonal frequency division multiplex, OFDM, signal provided over a radio frequency, RF, channel that includes at least one guard band, the OFDM signal including at least one pilot signal; and
mitigating phase noise based at least in part on the at least one pilot signal and further based on observations of signal content of the at least one guard band.

9. The method of claim 8, wherein mitigating the phase noise includes determining a deviation of the signal content of the at least one guard band from an expected signal content and mitigating the phase noise based at least in part on the deviation.

10. The method of claim 8, wherein the OFDM signal has subcarriers indexed from −N_{SR} to N_{SR}, and receiving the OFDM signal includes determining an N-point discrete Fourier transform, where N>2×N_{SR}+1 such that N−2×N_{SR}−1 subcarriers are outside the OFDM signal but within the N-point DFT.

11. (canceled)

12. The method of claim 8, further comprising selecting the at least one guard band to observe signal content based at least in part on a presence of signals adjacent to a guard band of the at least one guard band and a presence of interference in a guard band of the at least one guard band.

13. The method of claim 8, wherein a number of guard bands for observation of signal content is based at least in part on a bandwidth of the OFDM signal, wherein the larger the bandwidth of the OFDM signal, the fewer the guard bands for observation of signal content.

14. (canceled)

15. A wireless device, WD, configured to communicate with a network node, the WD comprising one or both of a radio interface and processing circuitry configured to:
receive an orthogonal frequency division multiplex, OFDM, signal provided over a radio frequency, RF, channel that includes at least one guard band, the OFDM signal including at least one pilot signal; and
mitigate phase noise based at least in part on the at least one pilot signal and further based on observations of signal content of the at least one guard band.

16. The WD of claim 15, wherein mitigating the phase noise includes determining a deviation of the signal content of the at least one guard band from an expected signal content and mitigating the phase noise based at least in part on the deviation.

17. The WD of claim 15, wherein the OFDM signal has subcarriers indexed from −N_{SR} to N_{SR}, and receiving the OFDM signal includes determining an N-point discrete Fourier transform, where N>2×N_{SR}+1 such that N−2×N_{SR}−1 subcarriers are outside the OFDM signal but within the N-point DFT.

18. (canceled)

19. The WD of claim 15, wherein the one or both of the radio interface and processing circuitry are configured to select the at least one guard band to observe signal content based at least in part on a presence of signals adjacent to a guard band of the at least one guard band and a presence of interference in a guard band of the at least one guard band.

20. The WD of claim 15, wherein a number of guard bands for observation of signal content is based at least in part on a bandwidth of the OFDM signal, wherein the larger the bandwidth of the OFDM signal, the fewer the guard bands for observation of signal content.

21. (canceled)

22. A method implemented in a wireless device, WD, that is configured to communicate with a network node, the method comprising:
receiving an orthogonal frequency division multiplex, OFDM, signal provided over a radio frequency, RF, channel that includes at least one guard band, the OFDM signal including at least one pilot signal; and
mitigating phase noise based at least in part on the at least one pilot signal and further based on observations of signal content of the at least one guard band.

23. The method of claim 22, wherein mitigating the phase noise includes determining a deviation of the signal content of the at least one guard band from an expected signal content and mitigating the phase noise based at least in part on the deviation.

24. The method of claim 22, wherein the OFDM signal has subcarriers indexed from −N_{SR} to N_{SR}, and receiving the OFDM signal includes determining an N-point discrete Fourier transform, where N>2×N_{SR}+1 such that N−2×N_{SR}−1 subcarriers are outside the OFDM signal but within the N-point DFT.

25. (canceled)

26. The method of claim 22, further comprising selecting the at least one guard band to observe signal content based at least in part on a presence of signals adjacent to a guard band of the at least one guard band and a presence of interference in a guard band of the at least one guard band.

27. The method of claim 22, wherein a number of guard bands for observation of signal content is based at least in part on a bandwidth of the OFDM signal, wherein the larger the bandwidth of the OFDM signal, the fewer the guard bands for observation of signal content.

28. (canceled)
